(19) United States
(12) Patent Application Publication
(10) Pub. No.: US 2014/0094975 A1
(43) Pub. Date: Apr. 3, 2014

(54) CONTROL SYSTEM FOR A MOBILE WATER FILTRATION UNIT, AND RELATED DEVICES, COMPONENTS, SYSTEMS AND METHODS

(71) Applicant: Elo Nielsen, Wake Forest, NC (US)

(72) Inventor: Elo Nielsen, Wake Forest, NC (US)

(21) Appl. No.: 14/041,523

(22) Filed: Sep. 30, 2013

Related U.S. Application Data
(60) Provisional application No. 61/707,369, filed on Sep. 28, 2012.
(60) Provisional application No. 61/857,468, filed on Jul. 23, 2013.

(51) Int. Cl. C02F 1/00

(52) U.S. Cl. CPC C02F 1/004
USPC 700/282

(57) ABSTRACT

A standardised, modular mobile water purification unit for the production of safe potable water and for treatment of wastewater is disclosed to fulfil the water need for humans, animals and households. In one embodiment, the unit can be based on a standardized climate-controlled container that is robust both physically and functionally, can be easily transported and quickly set up in remote regions and disaster areas. The unit may work for purification of water of brackish, sea or polluted surface water, and of wastewater, and can be customised to the given water type based on easy changeable treatment modules. The unit includes a rigid frame that can be removed from the container, and also includes a control system for remote monitoring and control of the unit.

### CROSS-REFERENCE TO RELATED APPLICATIONS

This application claims the benefit of priority under 35 U.S.C. §119 of U.S. Provisional Application Ser. No. 61/707,369 filed on Sep. 28, 2012 the content of which is relied upon and incorporated herein by reference in its entirety.

This application claims the benefit of priority under 35 U.S.C. §119 of U.S. Provisional Application Ser. No. 61/857,468 filed on Jul. 23, 2013 the content of which is relied upon and incorporated herein by reference in its entirety.

### BACKGROUND

The disclosure relates generally to water filtration and more particularly to a mobile water filtration unit, which may be used in areas with limited infrastructure and other areas where availability of potable water is limited.

Potable water is a necessity in all areas with human habitation. In most modern population centers, municipal water treatment facilities provide clean and potable water in areas that lack a clean groundwater or well water source, and also provide wastewater treatment services. However, in many locations around the world, the available groundwater sources are not suitable for human consumption, due to pollution, disease, and other hazards. In addition, many of these locations also lack a dedicated water treatment facility. Accordingly, there is a need for a mobile solution for water treatment in areas having limited infrastructure.

No admission is made that any reference cited herein constitutes prior art. Applicant expressly reserves the right to challenge the accuracy and pertinency of any cited documents.

### SUMMARY

Embodiments include a control system for remote monitoring and control of a standardised, modular mobile water purification unit for the production of safe potable water and for purification of wastewater to fulfil the water need for humans, animals, households, and industry. In one embodiment, the unit can be based on a standardized climate-controlled container that is robust both physically and functionally, can be easily transported and quickly set up in remote regions and disaster areas. The unit may work for purification of water of brackish, sea or polluted surface water, and of wastewater, and can be customised to the given water type based on easy changeable treatment modules.

An additional embodiment of the disclosure relates to a control module for a mobile water filtration unit for treating water in areas with limited infrastructure. The control module comprises a module frame configured to be mounted to a rigid frame, the frame defining an interior space configured to be removably disposed within an interior of a shipping container. The control module further comprises a processor and at least one treatment module interface configured to be operatively connected to at least one treatment module mounted to the rigid frame for operating the at least one treatment module responsive to instructions received from the processor. The control module further comprises at least one remote communication interface configured to communicate information regarding the source water intake, the at least one treatment module, and/or the at least one treated water output with between the mobile water filtration unit via the processor and a control unit located outside of the module frame.

An additional embodiment of the disclosure relates to a control unit for a mobile water filtration unit for treating water in areas with limited infrastructure. The control unit comprises a processor and at least one remote communication interface configured to communicate information regarding at least one treatment module of the mobile water filtration unit between the control unit via the processor and a control module of the mobile water filtration unit.

An additional embodiment of the disclosure relates to a method of controlling a mobile water filtration unit from a remote location. The method comprises operating a control interface for directing operation of at least one treatment module of a mobile water filtration unit. The method further comprises transmitting instructions from the control unit to a control module of the mobile water filtration unit responsive to operation of the control interface. The method further comprises wherein the control module is configured to operate the at least one treatment module of the mobile water filtration system in response to receiving instructions from the control unit.

An additional embodiment of the disclosure relates to a non-transitory computer readable medium comprising instructions for directing a processor to perform a method of controlling a mobile water filtration unit from a remote location. The method comprises operating a control interface for directing operation of at least one treatment module of a mobile water filtration unit. The method further comprises transmitting instructions from the control unit to a control module of the mobile water filtration unit responsive to operation of the control interface. The method further comprises wherein the control module is configured to operate the at least one treatment module of the mobile water filtration system in response to receiving instructions from the control unit.

An additional embodiment of the disclosure relates to a method of controlling a mobile water filtration unit from a remote location. The method comprises receiving instructions from a control unit at a control module of the mobile water filtration unit for operating at least one treatment module of a mobile water filtration unit. The method further comprises operating the at least one treatment module in response to receiving the instructions from the control unit.

An additional embodiment of the disclosure relates to a non-transitory computer readable medium comprising instructions for directing a processor to perform a method of controlling a mobile water filtration unit from a remote location. The method comprises receiving instructions from a control unit at a control module of the mobile water filtration unit for operating at least one treatment module of a mobile water filtration unit. The method further comprises operating the at least one treatment module in response to receiving the instructions from the control unit.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 illustrates an portable water treatment solution in which water treatment equipment is permanently mounted in a portable container;

FIGS. 2A and 2B illustrate a mobile water filtration unit suitable for treating water in areas with limited infrastructure, having a rigid frame configured to be removably disposed within an interior of a shipping container;

FIG. 3 illustrates a flowchart diagram of the different treatment modules and functions of the water treatment unit of FIGS. 2A and 2B;

FIGS. 4A and 4B illustrate additional views of the rigid frame according to the embodiment of FIGS. 2A and 2B;

FIGS. 5A and 5B illustrate strain deformation of an exemplary shipping container in a longitudinal and lateral direction, according to an exemplary embodiment;

FIGS. 6A through 6C illustrate detailed views of an exemplary foot 42 according to the embodiment of FIGS. 2A and 2B;

FIGS. 7A and 7B illustrate the water filtration system of FIGS. 2A and 2B disposed in a standard-sized shipping container and in communication with a plurality of control units;

FIG. 8 is a schematic diagram representation of additional detail regarding an exemplary form of an exemplary computer system that is adapted to execute instructions, according to an exemplary embodiment.

### DETAILED DESCRIPTION

Embodiments include a control system for remote monitoring and control of a standardised, modular mobile water purification unit for the production of safe potable water and for purification of wastewater to fulfil the water need for humans, animals, households, and industry. In one embodiment, the unit can be based on a standardized climate-controlled container that is robust both physically and functionally, can be easily transported and quickly set up in remote regions and disaster areas. The unit may work for purification of water of brackish, sea or polluted surface water, and of wastewater, and can be customised to the given water type based on easy changeable treatment modules.

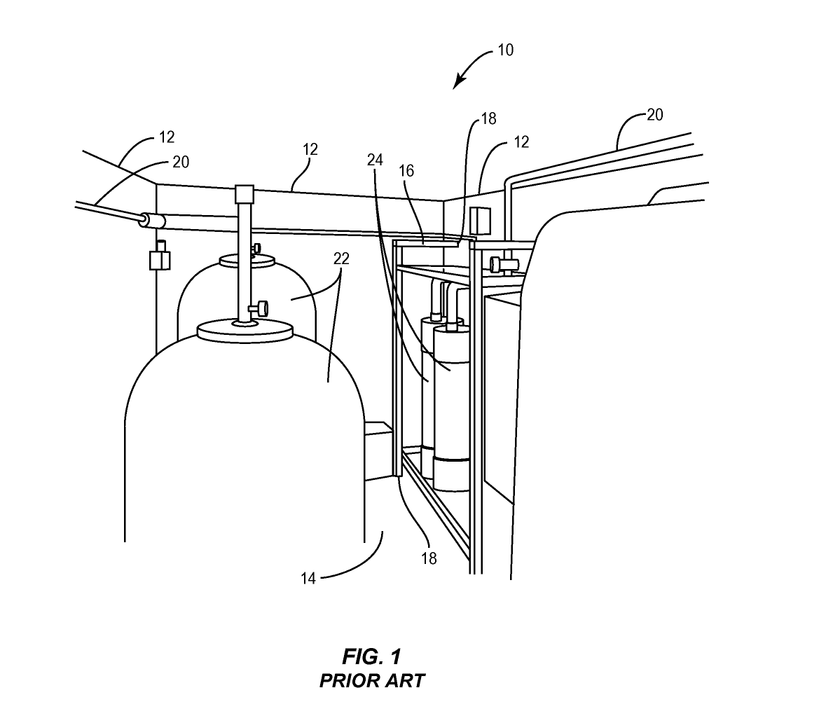

Before discussing exemplary embodiments of the disclosure, FIG. 1 illustrates an alternative portable water treatment solution in which water treatment equipment is permanently mounted in a portable container, such as a shipping container 10. The container 10 includes rigid walls 12 and floor 14. Within the container 10 a plurality of component support members 16 are arranged and permanently attached to the walls 12 and floor 14 of the container 10 by a plurality of weld points 18 or other permanent fastening mechanisms. Pipes/conduits 20 and a plurality of treatment tanks/components 22, 24 are secured to the walls 12, floor 14, and permanently attached component support members 16.

This arrangement has several limitations. For example, applying this design to a shipping container is unsuitable for transport in a container ship environment. Containers on a container ship are stacked one on top of the other, and are subject to extreme compression, stress, strain, and torsion forces that may effectively destroy the internal component support members 16, pipe/conduits 20, and treatment tank/components 22, 24 during transit. For example, a standard shipping container is designed to displace and flex within certain acceptable tolerances, but such flexing can deform and damage any equipment that is permanently attached to the wall and floor of a shipping container, such as container 10. Accordingly, it is desirable that a portable water treatment system be protected from these hazards during shipping.

Another limitation of the solution of FIG. 1 is that the volume within container 10 is limited, and a large amount of open space is required to permit operators and maintenance personnel to physically reach the individual treatment tanks/components 22, 24. Thus, because the entire volume of container 10 cannot be utilized with actual equipment, the capacity of the water treatment system within container 10 is reduced. This also complicates assembly of the unit, because the doors of the container 10 are the only access point for large components and for technician access, thereby limiting the design of the unit 10. In addition, replacing large components that have failed is difficult and can often require completely disassembling the unit 10 to remove the part.

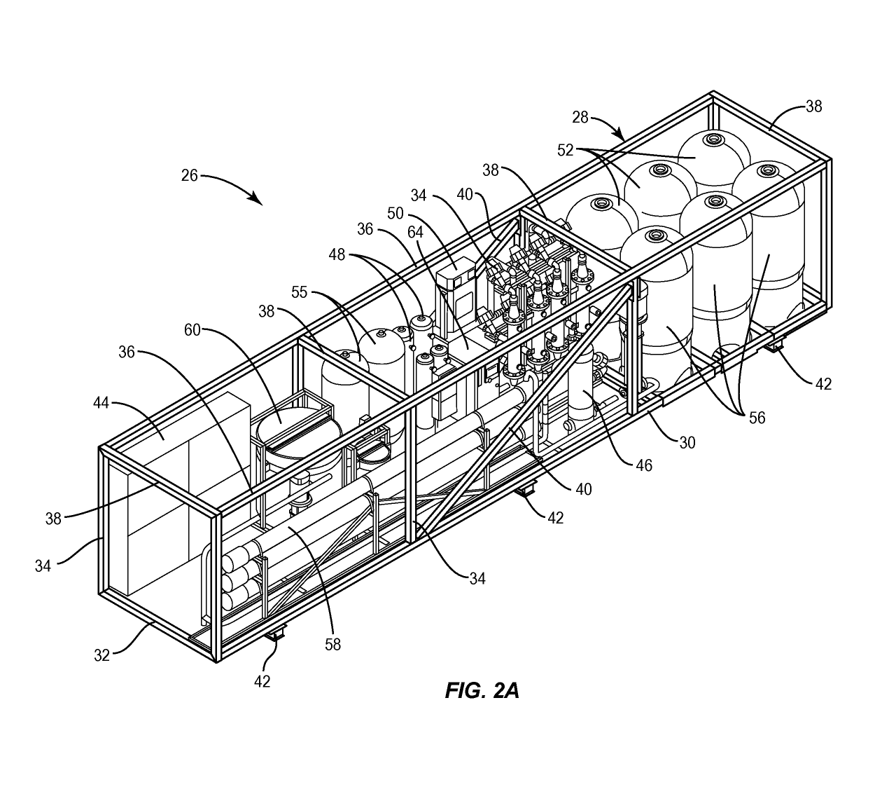

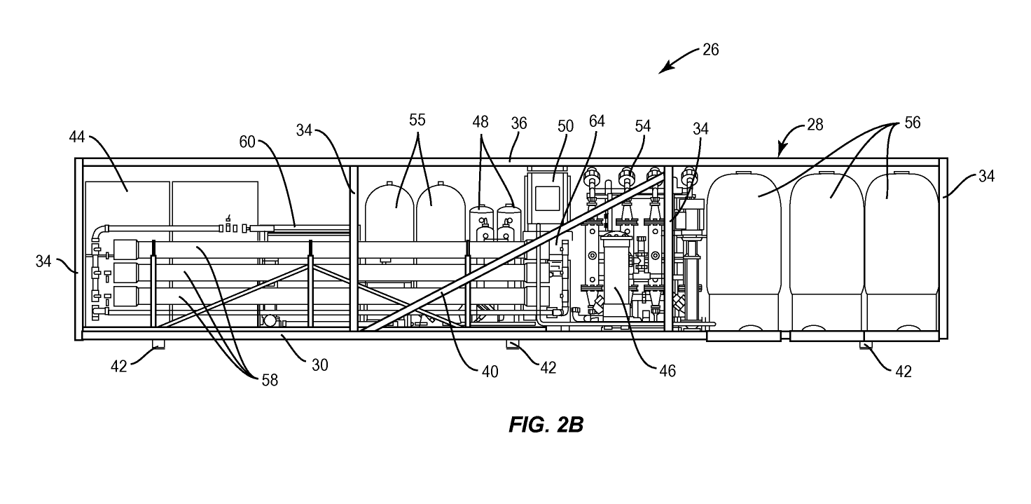

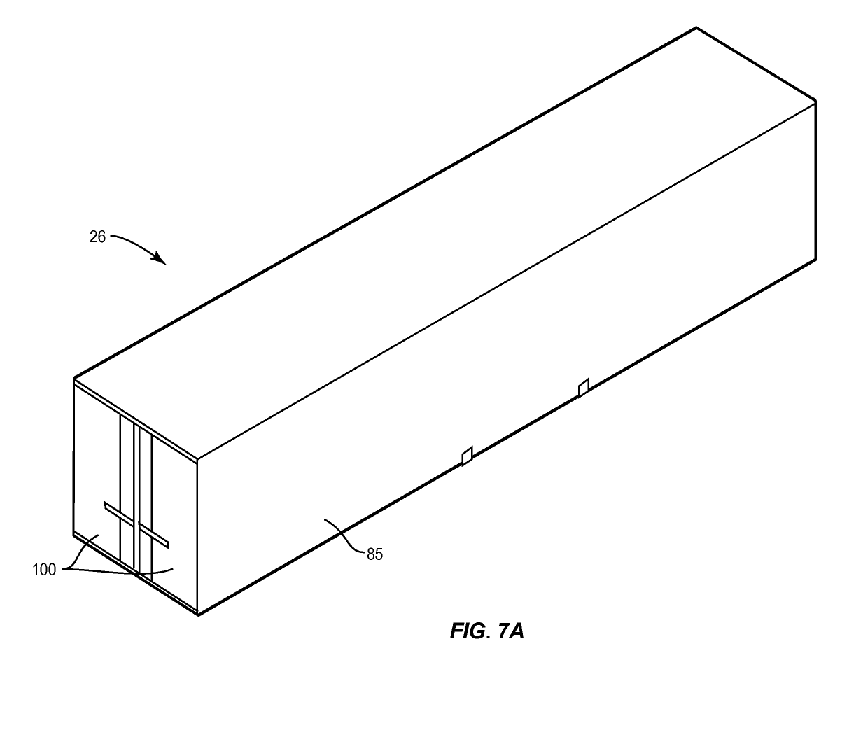

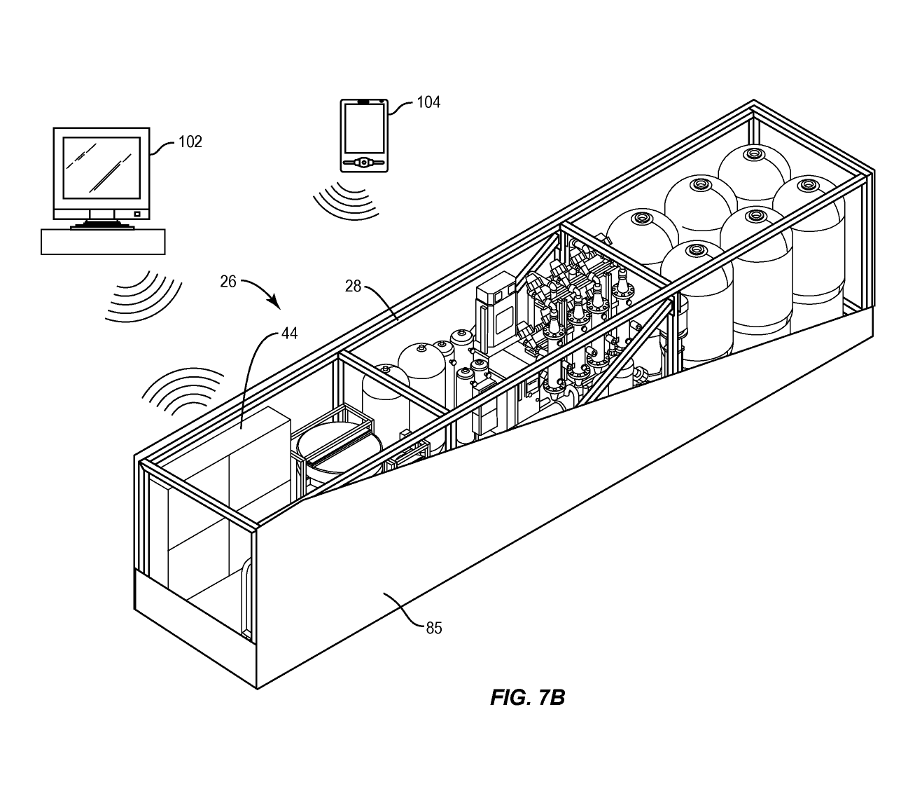

In this regard, FIGS. 2A and 2B illustrate a mobile water filtration unit 26 suitable for treating water in areas with limited infrastructure, and which addresses the limitations of the embodiment of FIG. 1. The mobile water filtration unit 26 includes a rigid frame 28 defining an interior space and configured to be removably disposed within an interior of a shipping container, which will be described in greater detail with respect to FIGS. 7A and 7B. The rigid frame 28 includes a plurality of longitudinal base beams 30 and lateral base beams 32, a plurality of support posts 34, and a plurality of longitudinal header beams 36 and lateral header beams 38, which are permanently connected together to form the rigid frame and which define the interior space. A plurality of diagonal beams 40 are also included to provide additional structural support and stiffness to the rigid frame 28. The rigid frame 28 rests on a plurality of feet 42 which are configured to support the rigid frame 28 within the shipping container (not shown).

The plurality of treatment modules are connected to the rigid frame 28 in series such that source water input into the system via a source water intake passes through and is treated by each of the treatment modules, before being output to an external water receptacle (not shown).

Each treatment module has a dedicated function, and is configured to be added to or removed from the water treatment unit 26 based on the desired functionality of the water treatment unit 26. For example, microfilter module 46 is configured to remove particles larger than 50 microns from untreated water. Examples of particles larger than 50 microns include clay and inorganic oxides. This function can also increase the time between cleaning for the downstream ceramic filter module (described below).

Oxidation process module 48 is configured to oxidize dissolved inorganic matter and soluble ions. For example, oxidation is used to convert dissolved iron, manganese, and other metal ions into particles that can be filtered from the water. The oxidation process module 48 may configured to add ozone to the source water. Ozone is a powerful oxidant that preferentially oxidizes electron rich functional groups of a molecule containing carbon-carbon double bonds and aromatic alcohols. It oxidizes the naturally occurring organic matter. It had been tested that oxidation before the filtering process reduces membrane fouling of the downstream ceramic filters. This module may also contain a high quality compressor with refrigeration dryer, which secures high quality clean compressed air for the oxygen production, controlled by an advanced control system (described below). The compressor is low noise and has optimal energy consumption system.

The oxidation module may also include an oxygen unit having 6 bar(g) dry compressed air feed into the generator where the pressure is built. N₂ is tied to a molecular sieve during the building of pressure, and the O₂ is allowed to pass through to the oxygen receiver tank. Zeolite type 13X is inside the columns of the oxygen generator and assists in oxygen production. The molecular sieve is fully regenerative and has an average life span of 40.000 operation hours. In this example, the purity of the oxygen will be 93%.

Ozone is then generated within enriched oxygen feed gas using an electrical corona discharge. Enriched oxygen feed gases are often used because ozone production is 2 to 3 times more energy efficient when an oxygen feed gas is used instead of air. The high-quality oxygen produced above is the main source for efficient production of ozone. The control system 44 also allows for monitoring and control of ozone levels, oxygen flow and alarms. The concentration and the amount of ozone injected in the raw water can be controlled, upstream of the ceramic filter module 54 and as a sterilizer and the end of the process.

The ultraviolet (UV) module 50 is configured to bombard the water with ultraviolet radiation in order to destroy harmful microorganisms within the water. UV light is electromagnetic radiation with a wavelength shorter than that of visible light, but longer than X-rays, that is, in the range 10 nm to 400 nm, corresponding to photon energies from 3 eV to 124 eV.

UV light does not affect taste, color or odor of the water. However, UV light is theoretically capable of destroying 99.9% of harmful microorganisms including: E. coli, Cryptosporidium and Giardia, when the light reaches the microorganisms. UV light penetrates and permanently alters the DNA of the microorganisms in a process called thymine dimerization. The microorganisms are inactivated and rendered unable to reproduce. The UV light with a wavelength from 200 to 280 nm is also used in the UV module 50 to activate the ozone to create oxygen radicals, which then combine with water to form —OH radicals, which further aids in the oxidation process.

Retention system module 52 is configured to retain water within the system 26 in order to allow processes such as the oxidation process to continue for a sufficient time to obtain an effective result. For example, depending on the composition of the untreated water, oxidation reaction time may vary for different materials.

The size and quantity of the retention system modules 52 is designed to give the correct reaction time. There can be a significant difference for the reaction time required depending on the matter. Some organics require only a few milliseconds of reaction time and other organics or inorganics require several minutes to finish the oxidation process. After this process, the matter has changed to a filterable form that the ceramic filter can efficiently remove from the source water. These filterable matters can now be separated and flushed out by the back flush function of the ceramic filter module 54.

A ceramic ultra filter module 54 is configured to filter smaller particles from the water. This filtration is extremely efficient, provided that larger particles are not present in the water, and the ceramic ultra filter module is flushed and kept clean on a regular basis. The flux through the filter can also constantly be optimized by the control module 44 to maintain the pressure drop across the filter as low as possible to optimize the energy efficiency of the ceramic filter module 54.

The control of the fouling of the ceramic filter module 54 is done by an advanced inline cleaning system that includes a high speed back pulse system which sends regular waves from the backside of the filter in combination with periodic injections of ozone on the “dirty” side of the filter. The purpose of the operation is to secure a flux higher than 60% of the flux with clean water and keep it at a constant flow rate. In addition, ozone helps destroy and break up particulate matter captured in the ceramic filter, but is non-reactive with the filter itself. Back flush tanks 55 are configured to compensate for pressure variations caused by the ceramic filter module 54. For example, during the back pulse operation, the back flush tanks 55 may receive the flushed material from the ceramic filter module 54. The back flush tanks 55 may include a flexible inner membrane to aid in maintaining the appropriate pressure across the ceramic filter module 54 to maintain the proper amount of downstream flow through the ceramic filter module 54. Therefore, the backflush tanks 55 are able to extend the useful life of the ceramic filter.

Granular activated carbon (GAC) module 56 utilizes a form of activated carbon with a high surface area and absorbs many compounds, including many toxic compounds. In this embodiment, the same tank housings are used for the retention modules 52 and GAC modules 56 in order to reduce the number of unique parts used. In this embodiment, the mobile water filtration unit includes three retention modules 52 and three GAC modules 56, but more or fewer of each may be employed in different embodiments, as desired. Activated carbon filters in many embodiments are used as secondary means to complement other, more robust, purification techniques. Activated charcoal can also remove chlorine from treated water, removing any residual protection remaining in the water protecting against pathogens. For example, ceramic/carbon core filters with a 0.5-micron or smaller pore size are excellent for removing bacteria and cysts while also removing chemicals.

The main purpose of the GAC module 56 is to work as a trap for excess ozone. Although ozone is an excellent decontaminant, it is essential to remove any residual ozone from the source water before it reaches the nanofiltration/reverse osmosis (NF/RO) module, described below. If ozone is able to continue to the NF or RO membrane, the membrane would be quickly oxidized and irreparably damaged. In some embodiments, the filtration system 26 may have an ozone alarm downstream of the GAC filter.

The NF/RO module 58 is configured to treat low salinity brackish or surface water. The NF module 58 can include reverse osmosis membranes as well for treating low and medium salinity water. The objective of nanofiltration systems is to reduce concentration specific components from the source water, usually hardness, iron, organics or color, while allowing monovalent ions to pass through. Some NF systems operate primarily for removal of low concentrations of pesticides sometimes present in the potable water at specific locations. Due to low salinity, low rejection and high permeability of nanofiltration membranes, the NF systems operate at low feed pressure, usually below 10 bar. Brackish RO systems treat low and medium salinity fed water and operate at feed pressure range of 10-15 bar. The recovery rate is in the range of 75%-85%. The recovery limiting factor is mainly concentration of sparingly soluble salts, mainly silica and CaSO₄.

A common problem with existing water cleaning systems is fouling of the NF/RO membranes, leading to a decrease in capacity and, if not properly dealt with, eventual total failure of the system. This is especially problematic in remote areas where systems must operate for longer periods. Fouling of NF/RO membranes is caused because of inadequate removal of larger particles and dissolved organic and inorganic matter. By including a variety of treatment modules upstream of the pre-treatment process, such as oxidation module 48, UV module 50 and ceramic filter module 54, which are capable of adequately filtering and purifying the water for potentially fouling agents, only limited fouling should occur downstream. In this manner, the system should be able to operate more reliably and with less power consumption.

Post-treatment modules 60 are configured to perform mineralization, pH adjustment, and other stabilizing treatments. The water purified by NF/RO module 58 is very corrosive and is “stabilized” by post-treatment modules 60 to protect downstream pipelines and storages, usually by adding lime or caustic to prevent corrosion of concrete lined surfaces. Liming material is used to adjust pH between 6.8 and 8.1 to meet the potable water specifications, primarily for effective disinfection and for corrosion control. In some cases, ozone may also be added as a sterilizer if the water is going to a storage system, such as tanks or bottle machines. Post-treatment modules 60 may also be configured to perform clean-in-place (CIP) and other functions.

Depending on the water the unit needs to purify, different modules may be arranged together in different configurations. This flexibility is another advantage of above described embodiments, which can be upgraded or changed to filter other types of water. As discussed above, some modules are designed to work together and/or to protect each other as well.

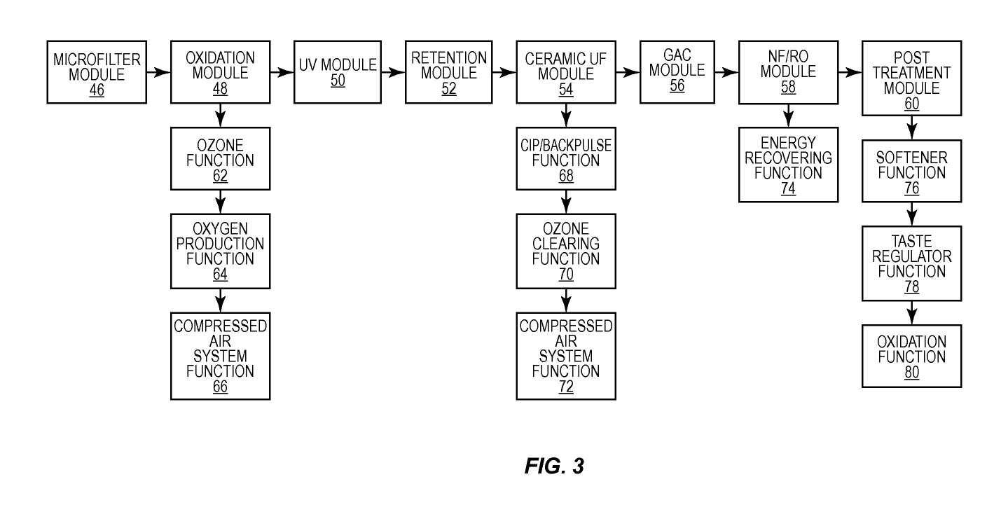

Referring now to FIG. 3, a flowchart diagram of the different modules of the water treatment unit 26 is illustrated. In addition to the modules described above with respect to FIGS. 2A and 2B, additional functions of certain modules are also described. For example, the oxidation process module 48 includes an ozone function 62 for applying ozone to the untreated water, an oxygen production function 64 for allowing the ozone to extract oxygen from the water, and a compressed air system function 66 for supplying oxygen to the oxidation process module.

The ceramic ultra filter module 54 also includes functions such as a backpulse function 68 for flushing the filter and preventing clogging, an ozone clearing function 70 for applying ozone to the filter, which removes particulates without reacting with or damaging the ceramic filter, and a compressed air system function 72 for providing oxygen to ceramic ultra filter module. The NF module 58 may also include an energy recovering function 74 for regeneratively capturing excess energy from the high pressure output of the NF module 58. For example, the high pressure output of the NF module 58 may drive a mechanical pump or motor to generate mechanical or electrical power that can be input back into other parts of the mobile water filtration unit 26. Finally, post-treatment module 60 includes a softener function 76, a taste regulator function 78, an oxidation function 80 for post-treatment of the potable water output.

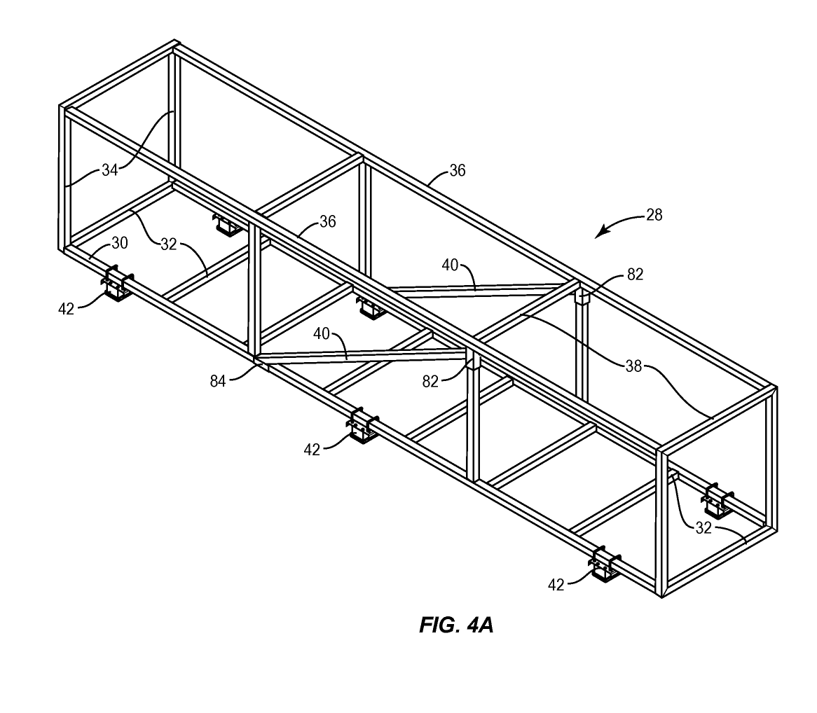

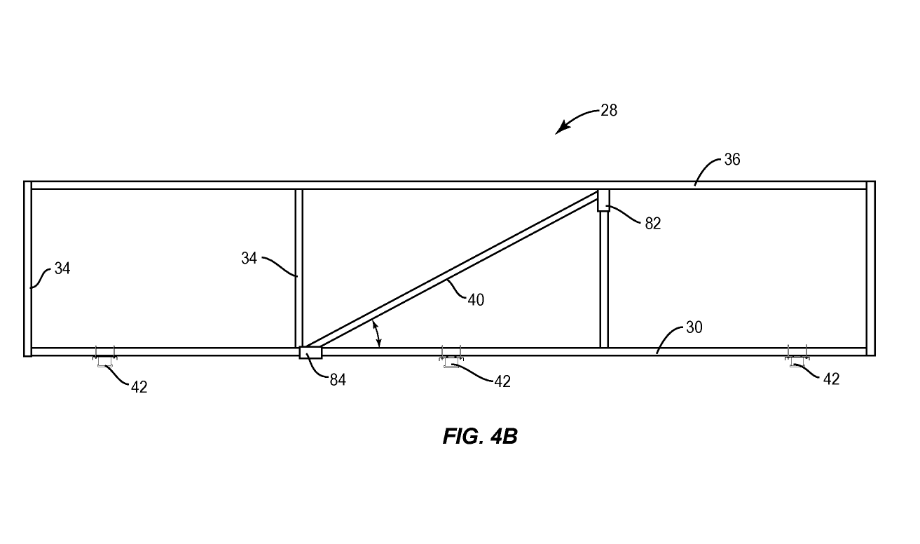

FIGS. 4A and 4B illustrate the rigid frame 28 according to the embodiment of FIGS. 2A and 2B. In this embodiment, diagonal beam 40 includes a vertical strut sleeve 82 and horizontal strut sleeve 84. These strut sleeves 82, 84 can be configured to be movable along a respective support post 34 and longitudinal base beams 30 in order to permit a predetermined amount of flexibility in the support frame. In an alternative embodiment, the support sleeves 82, 84 may be rigidly fastened to the support posts 34 and longitudinal base beams 30 to provide additional stiffening for the rigid frame 28.

In an exemplary embodiment, the rigid frame 28 is made of stainless steel, and is designed to allow sea transport in a container and at the same time protect against the huge forces that can appear under land, sea, or air transport. In one embodiment, the whole frame can be rolled, slid, or otherwise moved out of the container by any internal transport system, which makes it easy to allow larger service on site.

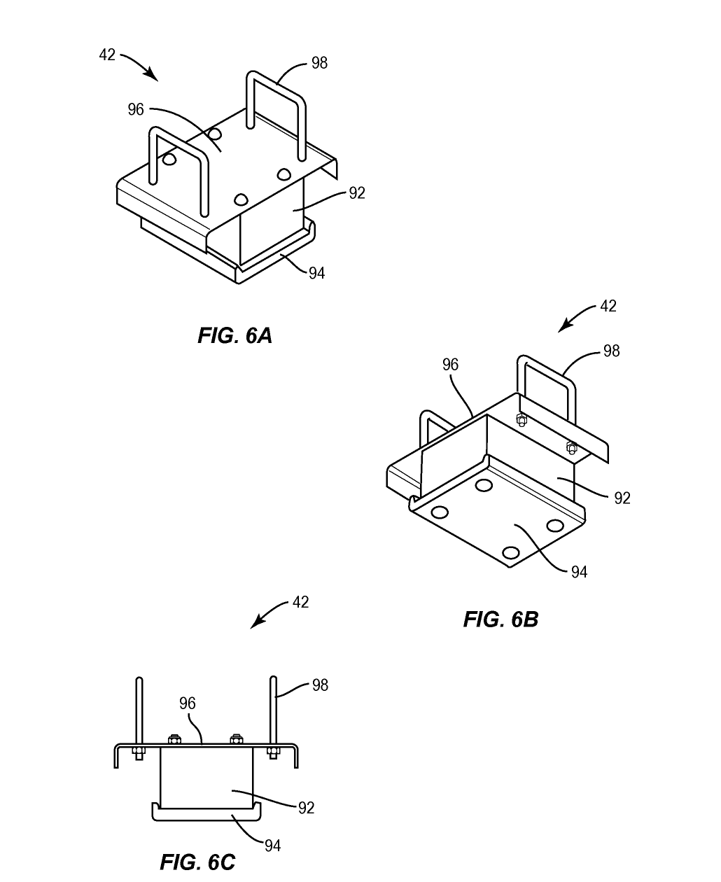

The embodiment of FIGS. 2A and 2B is very practical because the mounting of equipment can be performed in the workshop before the whole system can be slid into the cooling container. More importantly, this arrangement ensures that the system works when it arrives at its destination. As will be described below with respect to FIGS. 6A and 6B, the distance between the walls of the container in one embodiment is designed in the way that, even if the container is deflecting under transport, the wall of the container is not able to transfer any forces to the frame. In this example, the distance to the walls in every direction, except to the floor where it is mounted, is greater than 50 mm.

Because the frame 28 can be easily inserted and removed from a shipping container, all modules and other components can be mounted from the side of the frame instead of from the end. The two diagonal beams 40 can also be removed for easier access to the interior space. In addition, when service is necessary on site, the entire frame 26 can be removed from the container. Without these features, it is nearly impossible to exchange equipment placed in back of the container.

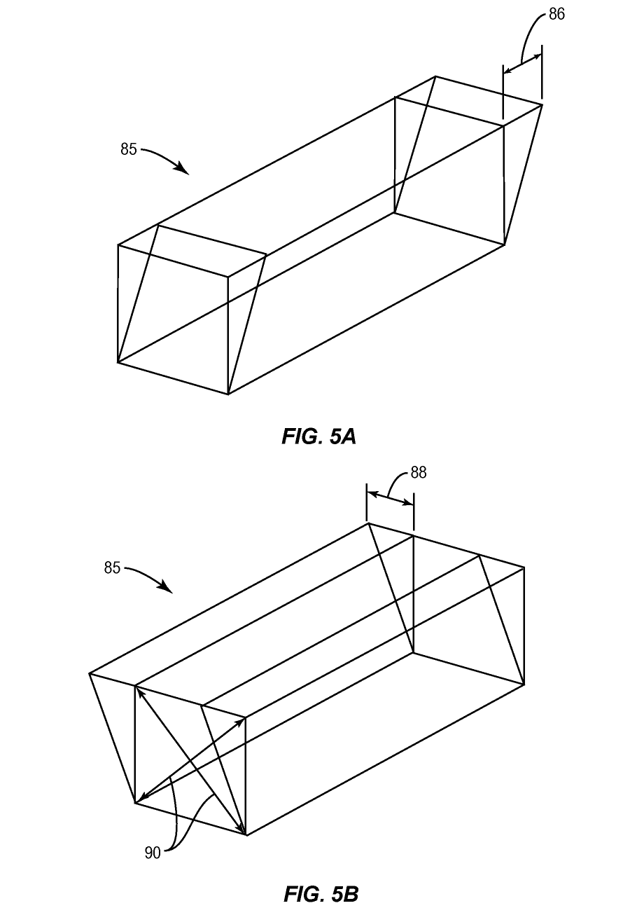

The dimensions of rigid support frame 28 may be set based on a standard tolerances for displacement and deformation of a shipping container 85, as illustrated in FIGS. 5A and 5B. FIG. 5A illustrates strain deformation 86 of shipping container 85 in a longitudinal direction, and FIG. 5B illustrates strain deformation 88 of shipping container 85 in a lateral direction. FIG. 5B also illustrates diagonal compression forces 90 that may be applied to the shipping container 85 when in a container ship environment.

FIGS. 6A through 6C illustrate detailed views of an exemplary foot 42 according to the embodiment of FIGS. 2A and 2B. In this example, foot 42 includes a rubber base 92 that rests on a skid surface 94, which permits the rigid frame to be slidably moved in and out of a shipping container. The shock absorbing foot 42 can also be designed to take up the forces which occur when the equipment is transported to different locations, and can also be designed to withstand the horizontal forces which can occur, for example, under an earthquake. The system can be designed so that all forces acting on the equipment in the frame must be transferred though the shock system. The shock absorber can be built as a rubber block, as cable to damp accelerations, or other suitable supports, and can also be configured to absorb forces applied to the frame 28 by the surrounding shipping container during transport. Base 92 is fastened to attachment bracket 96, which is in turn secured to the rigid frame by a pair of bolt brackets 98. In this manner, the complete water filtration system 26 can be moved in and out of the shipping container as needed. Because the rigid frame 28 is an open frame, this design also allows technicians and other personnel to access individual components of the water filtration system 26 from outside the interior space defined by the rigid frame 28. Thus, because additional space is not required within the interior space of rigid frame 28, additional and larger filtration components can be included within the interior space of the rigid frame 28, thereby increasing the capacity of the water filtration system 26 sufficient to supply potable water to a large village, for example, without increasing the overall volume of the system beyond the volume of a standard shipping container.

In this regard, FIGS. 7A and 7B illustrate the water filtration system 26 disposed in a standard-sized shipping container 85. The doors 100 of container 85 can be manually opened to allow the rigid frame 28 to be moved in or out of the container 85. FIG. 7B illustrates a cutaway view to illustrate the internal components of water filtration system 28 within the shipping container 85. In one embodiment, the container is built of stainless steel and aluminum, and includes climate-control equipment. This climate-control equipment can maintain the entire container 85 and contents at predetermined temperature, humidity and atmospheric conditions, which can help protect the components of the unit 26 during transport and during operation. For example, reverse osmosis (RO) membranes, which take out salt or very fine particles and are used in embodiments described herein, are made from Polyethylene and have a maximum allowed temperature of 50 degrees Celsius. However, a normal dry container placed in a ship or left in the sun on a dock can easy reach over 80 degrees Celsius inside in the absence of climate-control equipment. In some embodiments, the container 58 may also include a plurality of armored surfaces surrounding the interior space of the of the rigid frame configured to withstand small arms fire, or other military-style attack. These and other features make the above described embodiments suitable for military applications as well.

FIG. 7B also illustrates exemplary control units 102, 104, for controlling the operation of the mobile water filtration system 26 from a remote location. In the example of FIG. 7B, a computer terminal 102, such as a PC, and a mobile device 104, such as a smartphone, wirelessly communicates with the control module 44 of the mobile water filtration unit 26. The control module 44 and units 102, 104 can be equipped with a Wi-Fi connection, GPS phone system and/or satellite connection, for example, depending on the location the unit is to be placed. This allows the possibility to monitor the system from a local computer, or from a remote service center. The control system can also monitor whether a component is or is not an original part, whether a component is functioning properly, and/or whether a component needs repair or replacement.

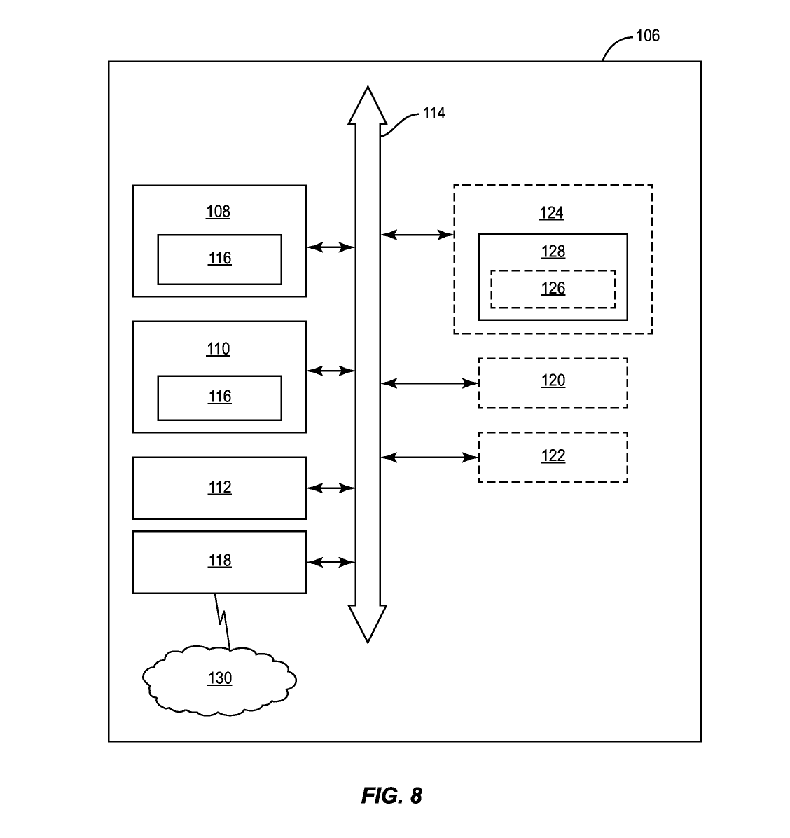

FIG. 8 is a schematic diagram of a generalized representation of an exemplary computer system that can be included in or interface with any of the control modules 44 or control units 102, 104, provided in the exemplary embodiments and/or their components described herein, wherein the exemplary computer system is adapted to execute instructions from an exemplary computer-readable medium of an embodiment.

Any of the control components disclosed herein can include a computer system. In this regard, FIG. 8 is a schematic diagram representation of additional detail regarding an exemplary form of an exemplary computer system 106 that is adapted to execute instructions. In this regard, the computer system 106 includes a set of instructions for causing the component(s) to provide its designed functionality. The component(s) may be connected (e.g., networked) to other machines in a LAN, an intranet, an extranet, or the Internet. The component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer. The exemplary computer system 106 in this embodiment includes a processing device or processor 108, a main memory 110 (e.g., read-only memory (ROM), flash memory, dynamic random access memory (DRAM) such as synchronous DRAM (SDRAM), etc.), and a static memory 112 (e.g., flash memory, static random access memory (SRAM), etc.), which may communicate with each other via a data bus 114. Alternatively, the processing device 108 may be connected to the main memory 110 and/or static memory 112 directly or via some other connectivity means. The processing device 108 may be a controller, and the main memory 110 or static memory 112 may be any type of memory, each of which can be included in the control module 44 and/or control units 102, 104 described herein.

The processing device 108 represents one or more general-purpose processing devices such as a microprocessor, central processing unit, or the like. More particularly, the processing device 108 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 108 is configured to execute processing logic in instructions 116 (located in the processing device 108 and/or the main memory 110) for performing the operations and steps discussed herein.

The computer system 106 may further include a network interface device 118. The computer system 106 also may or may not include an input 120 to receive input and selections to be communicated to the computer system 106 when executing instructions. The computer system 106 also may or may not include an output 122, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 106 may or may not include a data storage device 124 that includes instructions 126 stored in a non-transitory computer-readable medium 128. The instructions 126 may also reside, completely or at least partially, within the main memory 110 and/or within the processing device 108 during execution thereof by the computer system 106, the main memory 110 and the processing device 108 also constituting the computer-readable medium 128. The instructions 116, 126 may further be transmitted or received over a network 130 via the network interface device 118.

While the computer-readable medium 128 is shown in an exemplary embodiment to be a single medium, the term “computer-readable medium” should be taken to include a single medium or multiple media (e.g., a centralized or distributed database, and/or associated caches and servers) that store the one or more sets of instructions in a non-transitory form. The term “computer-readable medium” shall also be taken to include any medium that is capable of storing, encoding or carrying a set of instructions for execution by the processing device in a non-transitory form and that cause the processing device to perform any one or more of the methodologies of the embodiments disclosed herein. The term “computer-readable medium” shall accordingly be taken to include, but not be limited to, solid-state memories, optical and magnetic medium.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored instructions thereon, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modification combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A control module for a mobile water filtration unit for treating water in areas with limited infrastructure, comprising:
a module frame configured to be mounted to a rigid frame, the frame defining an interior space configured to be removably disposed within an interior of a shipping container;
a processor;
at least one treatment module interface configured to be operatively connected to at least one treatment module mounted to the rigid frame for operating the at least one treatment module responsive to instructions received from the processor;
at least one remote communication interface configured to communicate information regarding source water intake, the at least one treatment module, and/or at least one treated water output between the mobile water filtration unit via the processor and a control unit located outside of the module frame.

2. The control module of claim 1, wherein the processor is further configured to transmit instructions to the at least one treatment module for operating one or more functions of the at least one treatment module.

3. The control module of claim 1, wherein the processor is further configured to;
receive instructions from the control unit for operating one or more functions of the at least one treatment module; and
transmit instructions to the at least one treatment module for operating the one or more functions of the at least one treatment module in response to receiving the instructions from the control unit.

4. The control module of claim 1, wherein the remote communication interface is configured to communicate with the control unit wirelessly.

5. The control module of claim 1, wherein the remote communication interface is configured to communicate with the control unit using encrypted communications.

6. The control module of claim 1, wherein the processor is further configured to transmit instructions to the at least one treatment module to turn the at least one treatment module on or off.

7. The control module of claim 1, wherein the processor is further configured to;
receive instructions from the control unit to turn the at least one treatment module on or off; and
transmit instructions to the at least one treatment module to turn the at least one treatment module on or off in response to receiving the instructions from the control unit.

8. The control module of claim 1, wherein the processor is further configured to:
monitor at least one parameter associated with the at least one treatment module; and
communicate information relating to the at least one parameter to the control unit via the remote communication interface.

9. The control module of claim 8, wherein monitoring the at least one parameter comprises detecting a fault condition in the at least one treatment module.

10. The control module of claim 8, wherein monitoring the at least one parameter comprises detecting a change in operating efficiency in the at least one treatment module.

11. The control module of claim 8, wherein communicating information relating to the at least one parameter to the control unit comprises transmitting a notification that at least one component of the at least one treatment module requires maintenance.

12. The control module of claim 8, wherein communicating information relating to the at least one parameter to the control unit comprises automatically requesting that a replacement component be delivered to the location of the mobile water filtration unit.

13. A control unit for a mobile water filtration unit for treating water in areas with limited infrastructure, comprising:
a processor;
at least one remote communication interface configured to communicate information regarding at least one treatment module of the mobile water filtration unit between the control unit via a processor and a control module of the mobile water filtration unit.

14. The control unit of claim 13, further comprising a control interface configured to receive input and provide feedback to a user to permit the user to monitor and control operation of the at least one treatment module.

15. A method of controlling a mobile water filtration unit from a remote location, comprising the steps of:
operating a control interface for directing operation of at least one treatment module of a mobile water filtration unit; and
transmitting instructions from a control unit to a control module of the mobile water filtration unit responsive to operation of the control interface,
wherein the control module is configured to operate the at least one treatment module of the mobile water filtration system in response to receiving instructions from the control unit.

16. A non-transitory computer readable medium comprising instructions for directing a processor to perform a method of controlling a mobile water filtration unit from a remote location, comprising the steps of:
receiving input from a control interface for directing operation of at least one treatment module of the mobile water filtration unit; and
transmitting instructions from the control unit to a control module of the mobile water filtration unit responsive to operation of the control interface,
wherein the control module is configured to operate the at least one treatment module of the mobile water filtration system in response to receiving instructions from the control unit.

17. A method of controlling a mobile water filtration unit from a remote location, comprising the steps of:
receiving instructions from a control unit at a control module of the mobile water filtration unit for operating at least one treatment module of a mobile water filtration unit; and
operating the at least one treatment module in response to receiving the instructions from the control unit.

18. A non-transitory computer readable medium comprising instructions for directing a processor to perform a method of controlling a mobile water filtration unit from a remote location, comprising the steps of:
receiving instructions from a control unit at a control module of a mobile water filtration unit for operating at least one treatment module of a mobile water filtration unit; and
operating the at least one treatment module in response to receiving the instructions from the control unit.
